(19) United States
(12) Patent Application Publication
(10) Pub. No.: US 2020/0211126 A1
(43) Pub. Date: Jul. 2, 2020

(54) PREDICTION METHOD FOR SHALE OIL AND GAS SWEET SPOT REGION, COMPUTER DEVICE AND COMPUTER READABLE STORAGE MEDIUM

(71) Applicant: PetroChina Company Limited, Beijing (CN)

(72) Inventors: Lianhua Hou, Beijing City (CN); Xia Luo, Beijing City (CN); Zhi Yang, Beijing City (CN); Lijun Zhang, Beijing City (CN); Jinghong Wang, Beijing City (CN)

(21) Appl. No.: 16/572,600

(22) Filed: Sep. 17, 2019

(30) Foreign Application Priority Data
Dec. 29, 2018 (CN) 201811631935.4

(51) Int. Cl. G06Q 50/02; E21B 49/00; E21B 47/06; E21B 49/08; G06Q 10/06; G06Q 10/04

(52) U.S. Cl. CPC G06Q 50/02; E21B 49/00; G06Q 10/04; E21B 49/087; G06Q 10/06315; E21B 47/06

(57) ABSTRACT

The invention provides a prediction method for a shale oil and gas sweet spot region, a computer device and a computer readable storage medium, wherein the method comprises: acquiring an oil and gas content influencing parameter value, an oil and gas fluidity influencing parameter value and a compressibility influencing parameter value, and production cost data; determining a final produced oil equivalent corresponding to each influencing parameter value according to a pre-established final produced oil equivalent prediction model; determining an economic lower limit value of the final produced oil equivalent according to the production cost data; determining whether or not the shale oil and gas region to be predicted is a shale oil and gas sweet spot region. The above technical solution realizes quantitative prediction of a shale oil and gas sweet spot region, improves prediction accuracy, and provides scientific guidance for shale oil and gas exploration and development.

### INCORPORATION BY REFERENCE

An Application Data Sheet is filed concurrently with this specification as part of the present application. Each application that the present application claims benefit of or priority to as identified in the concurrently filed Application Data Sheet is incorporated by reference herein in its entirety and for all purposes.

### TECHNICAL FIELD

The invention relates to the technical field of shale oil and gas exploration and development, in particular to a prediction method for a shale oil and gas sweet spot region, a computer device and a computer readable storage medium.

### BACKGROUND

Shale oil and gas refers to use of a horizontal well volume fracturing technology to achieve industrial development. Shale oil and gas has become an important field of oil and gas exploration and development in the world, but the practice of exploration and development has proved that the shale for obtaining commercial oil and gas flow must meet certain conditions, and oil and gas production of shale oil and gas wells is controlled by various factors, and “sweet spot region” of shale oil and gas refers to an area where commercial oil and gas production can be obtained.

“Sweet spot region” of shale oil and gas proposed here is a concept of a certain regional range, not a single well concept, and is an area in which an average final produced oil equivalent (EUR_BOE) of production wells in a certain regional range is greater than an economic lower limit value (EUR_BOE_{cutoff}) of the final produced oil equivalent. Because a single well of shale oil and gas is controlled by many factors such as geology and engineering and the like, even though there is a big difference between an initial production and a final produced oil equivalent of a single well in a “sweet spot region”, an average final produced oil equivalent of all wells in the “sweet spot region” is greater than an economic lower limit value of the final produced oil equivalent, i.e., benefit development can be industrialized. In the prior art, schemes for predicting a sweet spot region of shale oil and gas all belong to qualitative prediction, and the prediction result is not accurate.

### SUMMARY

An embodiment of the present invention provides a prediction method for a shale oil and gas sweet spot region, for quantitatively predicting a shale oil and gas sweet spot region and improving precision of prediction of the shale oil and gas sweet spot region, the method comprising:

acquiring an oil and gas content influencing parameter value, an oil and gas fluidity influencing parameter value and a compressibility influencing parameter value of a shale target layer in a shale oil and gas region to be predicted, and production cost data;

determining a final produced oil equivalent corresponding to each influencing parameter value according to the oil and gas content influencing parameter value, the oil and gas fluidity influencing parameter value and the compressibility influencing parameter value, and a pre-established final produced oil equivalent prediction model;

determining an economic lower limit value of the final produced oil equivalent of the shale oil and gas region to be predicted according to the production cost data;

determining whether or not the shale oil and gas region to be predicted is a shale oil and gas sweet spot region according to the final produced oil equivalent corresponding to each influencing parameter value and the economic lower limit value of the final produced oil equivalent of the shale oil and gas region to be predicted.

The embodiment of the present invention further provides a computer device for quantitatively predicting a shale oil and gas sweet spot region and improving precision of prediction of the shale oil and gas sweet spot region, and the computer device comprises: a processor and a memory including computer readable instructions, when being executed, the computer readable instructions cause the processor to execute the following operations:

acquiring an oil and gas content influencing parameter value, an oil and gas fluidity influencing parameter value and a compressibility influencing parameter value of a shale target layer in a shale oil and gas region to be predicted, and production cost data; determining a final produced oil equivalent corresponding to each influencing parameter value according to the oil and gas content influencing parameter value, the oil and gas fluidity influencing parameter value and the compressibility influencing parameter value, and a pre-established final produced oil equivalent prediction model;

determining an economic lower limit value of the final produced oil equivalent of the shale oil and gas region to be predicted, according to the production cost data;

determining whether or not the shale oil and gas region to be predicted is a shale oil and gas sweet spot region according to the final produced oil equivalent corresponding to each influencing parameter value and the economic lower limit value of the final produced oil equivalent of the shale oil and gas region to be predicted.

The embodiment of the present invention further provides a computer readable storage medium including computer readable instructions, for quantitatively predicting a shale oil and gas sweet spot region and improving precision of prediction of a shale oil and gas sweet spot region, when being executed, the computer readable instructions cause a processor to execute at least the following operations:

acquiring an oil and gas content influencing parameter value, an oil and gas fluidity influencing parameter value and a compressibility influencing parameter value of a shale target layer in a shale oil and gas region to be predicted, and production cost data;

determining a final produced oil equivalent corresponding to each influencing parameter value according to the oil and gas content influencing parameter value, the oil and gas fluidity influencing parameter value and the compressibility influencing parameter value, and a pre-established final produced oil equivalent prediction model;

determining an economic lower limit value of the final produced oil equivalent of the shale oil and gas region to be predicted, according to the production cost data;

determining whether or not the shale oil and gas region to be predicted is a shale oil and gas sweet spot region according to the final produced oil equivalent corresponding to each influencing parameter value and the economic lower limit value of the final produced oil equivalent of the shale oil and gas region to be predicted.

The technical solution provided by the embodiment of the present invention achieves quantitatively predicting a shale oil and gas sweet spot region and improving precision of prediction of the shale oil and gas sweet spot region by: acquiring an oil and gas content influencing parameter value, an oil and gas fluidity influencing parameter value and a compressibility influencing parameter value of a shale target layer in a shale oil and gas region to be predicted, and production cost data; determining a final produced oil equivalent corresponding to each influencing parameter value according to the oil and gas content influencing parameter value, the oil and gas fluidity influencing parameter value and the compressibility influencing parameter value, and a pre-established final produced oil equivalent prediction model; determining an economic lower limit value of the final produced oil equivalent of the shale oil and gas region to be predicted, according to the production cost data; determining whether or not the shale oil and gas region to be predicted is a shale oil and gas sweet spot region according to the final produced oil equivalent corresponding to each influencing parameter value and the economic lower limit value of the final produced oil equivalent of the shale oil and gas region to be predicted, thereby providing scientific guidance for shale oil and gas exploration and development.

### BRIEF DESCRIPTION OF THE DRAWINGS

The drawings described here are used for providing further understanding to the present invention and constitute a part of the present application, and do not constitute definition to the invention. In the drawings:

FIG. 1 is a flow schematic diagram of a prediction method for a shale oil and gas sweet spot region in an embodiment of the present invention;

FIG. 2 is a principle schematic diagram of a prediction method for a shale oil and gas sweet spot region in an embodiment of the present invention;

FIG. 3 is a diagram showing a relationship between produced oil equivalent on the 180th day and final produced oil equivalent of a production well in an embodiment of the present invention;

FIG. 4 is a schematic diagram showing a relationship between a single well predicted EUR_BOE average value and an average value of predicted final produced oil equivalent in an embodiment of the present invention;

FIG. 5 is a schematic diagram showing a relationship corresponding to a final produced oil equivalent prediction model which corresponds to an organic matter maturity value in an embodiment of the present invention;

FIG. 6 is a schematic diagram showing a relationship corresponding to a final produced oil equivalent prediction model which corresponds to a total organic carbon content value in an embodiment of the present invention;

FIG. 7 is a schematic diagram showing a relationship corresponding to a final produced oil equivalent prediction model which corresponds to a total porosity value in an embodiment of the present invention;

FIG. 8 is a schematic diagram showing a relationship corresponding to a final produced oil equivalent prediction model which corresponds to an effective shale thickness value in an embodiment of the present invention;

FIG. 9 is a schematic diagram showing a relationship corresponding to a final produced oil equivalent prediction model which corresponds to an original formation pressure value in an embodiment of the present invention;

FIG. 10 is a schematic diagram showing a relationship corresponding to a final produced oil equivalent prediction model which corresponds to a clay volume content value in an embodiment of the present invention;

FIG. 11 is a schematic diagram of distribution of “sweet spot region” in the lower section of Eaglepool in an embodiment of the present invention;

FIG. 12 is a structural block diagram of a computer device in an embodiment of the invention.

### DETAILED DESCRIPTION OF EMBODIMENTS

In order to more clearly explain purpose, technical solution and advantages of the invention, hereinafter the invention will be further described in detail in combination with the embodiments and the accompanying drawings. Here, the schematic embodiments of the invention and the description thereof are used for explaining the invention and do not constitute definition to the invention.

The inventor has found that there are three solutions which are related to prediction of shale oil and gas “sweet spot region” in the prior art: the first one is qualitative prediction using shale geological parameters; the second one is prediction using engineering parameters; and the third one is qualitative and comprehensive prediction using “three qualities” being geological, engineering and economic. In the prior art, the quantitative prediction method for “sweet spot region” is not given, and the parameters adopted in the prediction have a superimposed effect on a final produced oil equivalent, so that a prediction result of “sweet spot region” cannot be accurately obtained.

In the prior art, three solutions of the technology related to the prediction of shale oil and gas “sweet spot region” all have defects, and cannot satisfy the prediction of shale oil and gas “sweet spot region”, and prediction result coincidence rate is low. These three solutions are described below.

I. Technology of qualitative prediction using shale geological parameters. The qualitative prediction of “sweet spot region” is carried out based on a shale type, rock structure, mineral composition and content, rock microfacies and other similar parameters. The defect of this technique is that the degree of thermal evolution of shale organic matter, an effective shale thickness, a shale porosity and other similar parameters are not taken into account, and the qualitative prediction method of “sweet spot region” is given only from the perspective of rock, which is difficult to operate in the actual prediction of “sweet spot region”, so that under the condition of no coring well, the prediction parameters are difficult to obtain, and the prediction coincidence rate is low.

II. Technology of prediction using engineering parameters. In the case of shale oil and gas without reservoir reformation, a natural production capacity cannot be obtained or is very low, and commercial oil and gas flow cannot be obtained. Although being an important aspect for controlling productivity of shale oil and gas, engineering technology is only one aspect that affects the productivity of shale oil and gas, without consideration of characteristics of shale itself, resulting in a low rate of coincidence between the prediction result and an actual result.

III. Technology of qualitative and comprehensive prediction using “three qualities” being geological, engineering and economic. In this technology, the conditions affecting the productivity of shale oil and gas are fully taken into account, but only lower limit values of some parameters are given empirically, however, for these lower limit values, there is no consideration of relevant influencing factors and the great difference among lower limit values of the same parameter under different conditions, and no corresponding calculation method is given. It is proposed that when all parameters in a “sweet spot region” satisfy their respective lower limit values, the prediction coincidence rate of “sweet spot region” is low because the lower limit value of each prediction parameter is single and no relevant application condition is considered.

Accordingly, according to tests in practice, the existing prediction techniques for “sweet spot region” of shale oil and gas have defects, and the prediction coincidence rate for “sweet spot region” is very low so that production demands cannot be satisfied, therefore, there is an urgent need for a feasible and highly accurate “sweet spot region” prediction technology. The present invention is proposed based on the state of the prior art, it can solve the defects and disadvantages of the prior art and can meet the production demands.

In addition, predecessors' researches are all limited to prediction of shale oil and gas production per well and a final recovery ratio, and the prediction result differs greatly from the production of an actual well. Accordingly, in consideration of the technical problems mentioned above, the present invention proposes that by preferably controlling shale oil and gas final produced oil equivalent parameters, on the basis of prediction by a single factor (an influencing parameter, which may also be referred to a determining parameter, a determining factor, a control parameter), the prediction of a shale oil and gas final produced oil equivalent is realized, and preferably “sweet spot region” of shale oil and gas is predicted and the prediction result well coincides with an actual development effect. The prediction solution of a shale oil and gas sweet spot region is described in detail as follows.

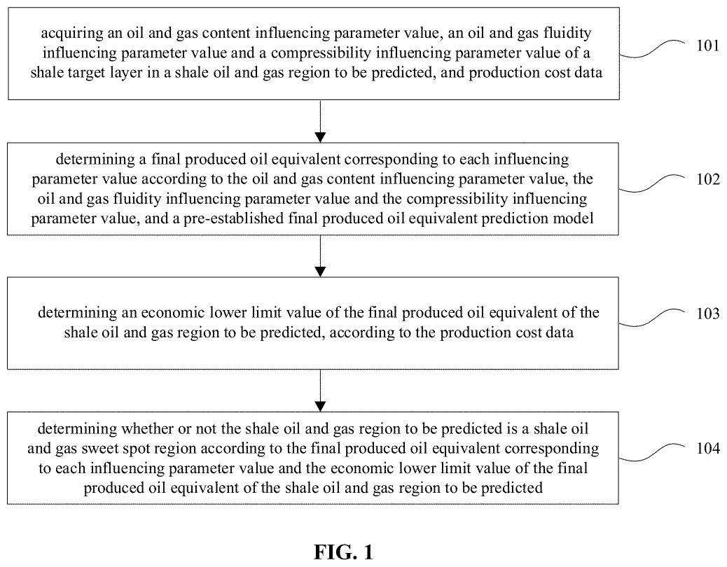

FIG. 1 is a flow schematic diagram of a prediction method for a shale oil and gas sweet spot region in an embodiment of the present invention. As shown in FIG. 1, the method comprises:

step 101: acquiring an oil and gas content influencing parameter value, an oil and gas fluidity influencing parameter value and a compressibility influencing parameter value of a shale target layer in a shale oil and gas region to be predicted, and production cost data;

step 102: determining a final produced oil equivalent corresponding to each influencing parameter value according to the oil and gas content influencing parameter value, the oil and gas fluidity influencing parameter value and the compressibility influencing parameter value, and a pre-established final produced oil equivalent prediction model;

step 103: determining an economic lower limit value of the final produced oil equivalent of the shale oil and gas region to be predicted, according to the production cost data;

step 104: determining whether or not the shale oil and gas region to be predicted is a shale oil and gas sweet spot region according to the final produced oil equivalent corresponding to each influencing parameter value and the economic lower limit value of the final produced oil equivalent of the shale oil and gas region to be predicted.

The technical solution provided by the embodiment of the present invention achieves quantitatively predicting a shale oil and gas sweet spot region and improving precision of prediction of a shale oil and gas sweet spot region by: acquiring an oil and gas content influencing parameter value, an oil and gas fluidity influencing parameter value and a compressibility influencing parameter value of a shale target layer in a shale oil and gas region to be predicted, and production cost data; determining a final produced oil equivalent corresponding to each influencing parameter value according to the oil and gas content influencing parameter value, the oil and gas fluidity influencing parameter value and the compressibility influencing parameter value, and a pre-established final produced oil equivalent prediction model; determining an economic lower limit value of the final produced oil equivalent of the shale oil and gas region to be predicted, according to the production cost data; determining whether or not the shale oil and gas region to be predicted is a shale oil and gas sweet spot region according to the final produced oil equivalent corresponding to each influencing parameter value and the economic lower limit value of the final produced oil equivalent of the shale oil and gas region to be predicted, thereby providing scientific guidance for shale oil and gas exploration and development.

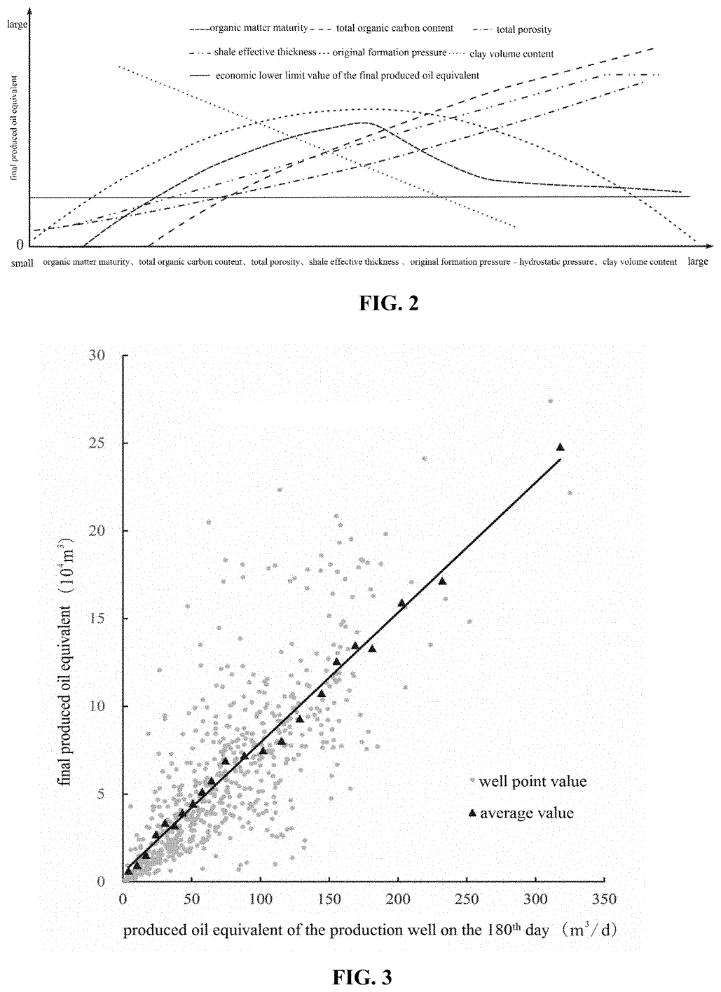

The steps involved in the embodiment of the present invention will be described below with reference to FIGS. 2 to 11.

I. Firstly, the process of pre-establishing a final produced oil equivalent prediction model before prediction is introduced.

In one embodiment, the final produced oil equivalent prediction model may be established by the following method:

obtaining oil and gas production data of a shale section production well in a target layer of a research region, as well as an oil and gas content influencing parameter value, an oil and gas fluidity influencing parameter value and a compressibility influencing parameter value of the target layer in the research region;

predicting a final produced oil equivalent of the shale section production well in the target layer of the research region according to the oil and gas production data within a preset time period;

normalizing a horizontal section length, number of fracturing sections, number of fracturing clusters and supporting dose used per meter of the final produced oil equivalent of the production well in the target layer of the research region;

acquiring an average value of the final produced oil equivalent within a preset interval of an influencing parameter value according to the interval by using the normalized values of the final produced oil equivalent of the production well in the target layer of the research region, and establishing a final produced oil equivalent prediction model corresponding to each influencing parameter value.

In specific implementations, the horizontal section length, the number of fracturing sections, the number of fracturing clusters and the supporting dose used per meter are used to normalize the final produced oil equivalent when establishing the final produced oil equivalent prediction model, and in addition, a method of acquiring an average value of the final produced oil equivalent within a certain interval of each independent parameter eliminates the difference of the final produced oil equivalent that is caused by engineer factors, and accurate evaluation (prediction) of a geological “sweet spot region” is truly realized, thereby improving precision of prediction of a shale oil and gas sweet spot region.

In one embodiment, predicting a final produced oil equivalent of a shale section production well in a target layer of a research region according to the oil and gas production data within a preset time period may include:

establishing a monthly oil and gas production prediction model of the production well according to data of oil production equivalent of the production well in 4 months near the 180th day;

determining an oil equivalent economic lower limit value of the production well according to the monthly oil and gas production prediction model and production cost data;

determining a final produced oil equivalent of the production well according to the oil equivalent economic lower limit value of the production well and oil and gas production of the production well in all previous months.

In specific implementations, when establishing the final produced oil equivalent prediction model, the embodiment of the present invention proposes a method for determining a final produced oil equivalent model by utilizing monthly oil and gas production data of the shale oil and gas production well during production time near the 180th day, to thereby improve the prediction accuracy effectively.

The process of establishing the final produced oil equivalent prediction model will be described in further detail below.

1. Firstly, collecting oil and gas production data of a shale section production well in a target layer of a research region, acquiring a monthly oil and gas production prediction model of the production well, acquiring an oil equivalent economic lower limit value of the production well based on the acquired oil and gas production model, and acquiring a final produced oil equivalent of the production well based on the oil equivalent economic lower limit value and previous oil and gas production;

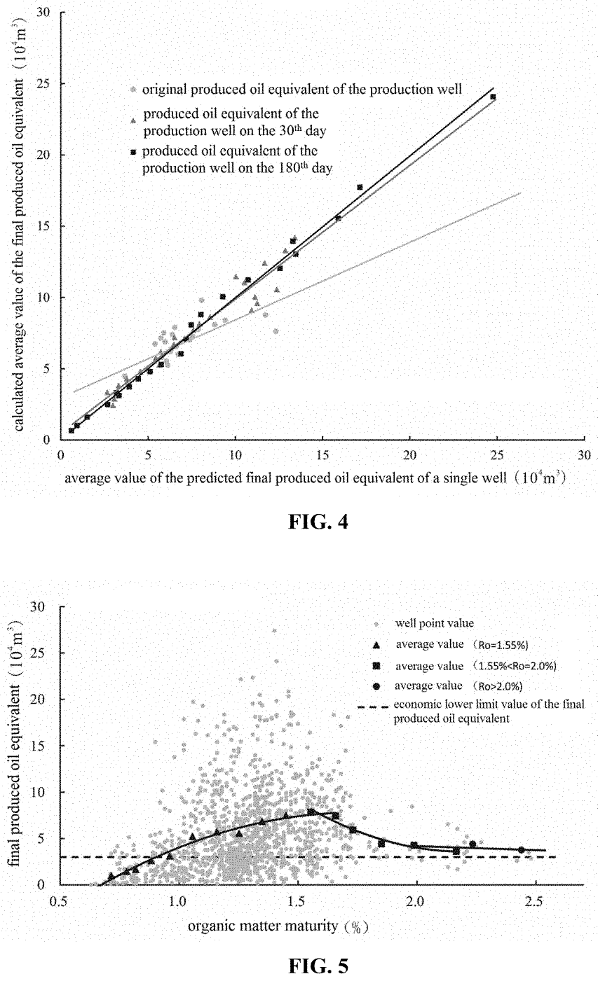

By analyzing oil and gas production decline relationship of multiple shale oil and gas production wells and using normal oil and gas production data of the production well on the 180th day, a final produced oil equivalent may be predicted, and an error between the predicted final produced oil equivalent and an actual value is smaller than 5% (see FIGS. 3 and 4). In order to obtain more stable production data of the production well, the produced oil equivalent of the production well during 4 months (which may be the 4th, 5th, 6th and 7th months of production wells) near the 180th day is acquired and normalized, and empirical parameters in a monthly oil and gas production model are preferably determined as follows:

using preferably monthly oil and gas production of the production well in the 4th, 5th, 6th and 7th months and model 1 (the following equation (1)) to form a super equation set, and then using regression analysis to solve empirical coefficients in the model 1 . According to conversion from a calorific value of natural gas into oil equivalent, natural gas of 1490 m³ under standard conditions (20° C., 1 standard atmospheric pressure) is preferably used as oil equivalent of 1 m³.

A calculation model for the monthly oil production equivalent of the production well is as follows:

Qₜ=a₁t^{b}^{₁}; (1)

in the equation, Qₜ is normalized oil equivalent of the tth month, m³; a₁ and b₁ are empirical parameters, which can be obtained preferably by obtaining the monthly oil production equivalent of the production well in the 4th, 5th, 6th and 7th months.

Wherein, the monthly oil production equivalent is normalized by a model 2 (the following equation (2)):

$${Q}_{t} = {Q}_{t\_i} \times \frac{365 / 12}{{t}_{i}} ; \qquad ( 2 )$$

in the equation, Q_{t_i} is oil equivalent of the i th month, m³; tᵢ is number of production days in the i th month, day.

An oil equivalent economic lower limit value of the production well means such an oil equivalent that value of oil equivalent produced in the current month is equal to operating cost of the well in that month, and the oil equivalent economic lower limit value is obtained by a model 3 (the following equation (3)):

Opexᵢ−(Q_{BOE_i}×P_{BOE})=0; (3)

in the equation, Opexᵢ is operating cost of the i th month, tens of thousands yuan; Q_{BOE_i} is a produced oil equivalent in the i th month, m³; P_{BOE} is price of oil equivalent, tens of thousands yuan/m³.

A calculation model for a final produced oil equivalent EUR_BOE of the production well (the following equation (4)) is as follows:

$$EUR\_BOE = {\sum }_{t = 1}^{n} {Q}_{t} ; \qquad ( 4 )$$

in the equation, EUR_BOE is the final produced oil equivalent, m³; n is the cumulative number of production months of the production well when value of the monthly produced oil equivalent of the production well is equal to the operating cost of the well in that month.

In specific implementations, the above equation (2) is used for normalizing an oil equivalent, the equation (1) is use for predicting an oil equivalent production, the equation (3) is used for determining maximum time for producing economic oil equivalent, and the equation (4) is used for determining the cumulative oil equivalent when the production well reaches the economic lower limit production oil equivalent. Specifically, the oil equivalent of the production well is obtained from the equation (1), the maximum production time is obtained from the equation (3), and the final produced oil equivalent of the production well is obtained from the equation (4).

2. Secondly, collecting logging data, core analysis data and production test data of the target layer in the research region, and acquiring an oil and gas content influencing parameter value, an oil and gas fluidity influencing parameter value and a compressibility influencing parameter value of the target layer in the research region from these data.

In one embodiment, the oil and gas content influencing parameters may include a total organic carbon content, a maturity of organic matter, and an effective shale thickness; the oil and gas fluidity influencing parameters may include a total porosity of shale and an original formation pressure; the compressibility influencing parameter may include a clay volume content.

In specific implementations, six independent parameters of the oil and gas content, oil and gas fluidity and shale compressibility are preferred, and relationship models with the final produced oil equivalent are established, which causes the control effect of the independent parameters on the final produced oil equivalent to truly reappear, eliminates mutual influence of multiple parameters in the prior art and improves precision of prediction of a shale oil and gas sweet spot region.

The discovery process and principle for prediction that is carried out by the inventor using these six independent influencing parameters are described below.

Whether the shale oil and gas has an industrial development value depends on the oil and gas content, the oil and gas fluidity and the shale compressibility in the shale target layer, and FIG. 2 is a schematic diagram thereof.

The oil and gas content depends on the total organic carbon content (TOC), the maturity of organic matter (a vitrinite reflectance Ro) and the effective shale thickness (He_{_Shale}) of the shale. TOC represents a content of organic matter in the shale and an potential of an oil and gas content influencing parameter, an oil and gas fluidity influencing parameter and a shale compressibility influencing parameter of a shale target layer within a shale oil and gas region to be predicted for generation of oil and gas. In the case that other conditions are the same, with the increase of TOC, the final produced oil equivalent (EUR_BOE) increases, and there is a positive correlation between them. Ro represents ability of organic matter in shale transforming into oil and gas, and meanwhile Ro represents oil and gas property, density of crude oil in the shale may decrease gradually and the gas-oil ratio may rise gradually with the increase of Ro, the oil and gas fluidity may gradually meliorate, but with the increase of Ro, dominance of oil in the shale is changed gradually into dominance of condensate oil and natural gas in the shale, and when Ro exceeds a certain value, the shale contains oil only, but with the increase of Ro, gas content of the shale reaches a maximum value and then gradually decreases, and thus EUR_BOE shows a tendency of firstly increasing and then decreasing with the increase of Ro. The effective shale thickness is directly proportional to the oil and gas content of the shale, the oil and gas content increases with the increase of the effective shale thickness, but there is a certain range of fracturing transformation of the shale in a longitudinal direction, and the effective shale thickness for fracturing transformation has an upper limit value, EUR_BOE increases with the increase of the effective shale thickness within a range of the upper limit value, and when it is larger than the upper limit value, EUR_BOE is not correlated to the effective shale thickness.

The oil and gas fluidity mainly depends on a total porosity of shale and a difference (ΔP_{F-S}) between original formation pressure and hydrostatic pressure. There is a good positive correlation between the total porosity and permeability of shale formation. The permeability increases with the increase of the total porosity (φₜ), thus fluidity of the shale is represented by the total porosity, and EUR_BOE increases with the increase of ϕₜ. ΔP_{F-S} represents power of the formation for producing oil and gas, ΔP_{F-S} of the shale formation increases with the increase of burial depth, Ro increases with the increase of the burial depth, the oil and gas content in the shale changes, which causes that EUR_BOE shows a tendency of firstly increasing and then decreasing with the increase of ΔP_{F-S}.

Shale compressibility mainly represents the ability to produce fractures by shale transformation. If other conditions are the same, the better the compressibility is, the higher the oil and gas production is. Clay mineral content directly controls the compressibility of shale, and the smaller the clay content is, the better the compressibility is. Accordingly, the shale compressibility is represented by clay volume content V_{Caly}), and there is a negative correlation between them.

Therefore, the inventor proposes a method for establishing a prediction model by utilizing a sectional EUR_BOE average value of different parameters after normalizing a horizontal section length, number of fracturing sections, number of fracturing clusters and supporting dose used per meter of EUR_BOE of the production well in the target layer of the research region, (which may include: acquiring a corresponding EUR_BOE average value at a certain interval for TOC, Ro, ϕₜ, He_{_Shale}, ΔP_{F-S}, V_{Caly}, respectively, according to the final produced oil equivalent of the production well and TOC, Ro, ϕₜ, He_{_Shale}, ΔP_{F-S}, V_{Caly} data; and obtaining a EUR_BOE prediction model according to the EUR_BOE average values that are obtained according to the parameters TOC, Ro, ϕₜ, He_{_Shale}, ΔP_{F-S}, V_{Caly}, respectively).

By establishing a calculation model between TOC, Ro, ϕₜ, He_{_Shale}, ΔP, V_{Caly} and EUR_BOE, and acquiring a ratio (EUR_BOE_{Rate}) of EUR_BOE to EUR_BOE_{cutoff} by utilizing the above parameters, contribution of the parameter on EUR_BOE will be obtained. An evaluation result SW_{index} of a “sweet spot region” in the target layer of the research region is obtained by cumulative multiplication of EUR_BOE_{Rate} obtained using the above parameters, and when SW_{index}≥1, it is a “sweet spot region”.

In specific implementations, the method includes collecting logging data, core analysis data and production test data of the target layer in the research region, acquiring TOC, Ro, φₜ, He_{_Shale}, ΔP_{F-S} and V_{Caly}, of the target layer in the research region, establishing a EUR_BOE prediction model by utilizing TOC, Ro, φₜ, He_{_Shale}, ΔP _{F-S} and V_{Caly} of the target layer in the research region, and realizing prediction of EUR_BOE by each parameter.

The practice of exploration and development has proved that there are many factors controlling oil and gas production of a shale. Prediction of EUR_BOE must include main independent parameters which control EUR_BOE. On the basis of analysis of many parameters controlling EUR_BOE, the present invention proposes six independent parameters that are TOC, Ro, φₜ, He_{_Shale}, ΔP_{F-S} and V_{Caly} of the shale, for predicting EUR_BOE. Before establishing the model, it is necessary to normalize a horizontal section length, number of fracturing sections, number of fracturing clusters and supporting dose used per meter for EUR_BOE of the production well in the target layer of the research region, preferably normalizing average values of the horizontal section length, the number of fracturing sections, the number of fracturing clusters and the supporting dose used per meter of the target layer in the research region. The normalized model is:

$$EUR\_BOE = {EUR\_BOE}_{i} \times {\sum }_{i = 1}^{n} \frac{{Para}_{i}}{{Para\_av}_{i}} ; \qquad ( 5 )$$

in the equation, EUR_BOE is the final produced oil equivalent of the production well after normalization, m³; EUR_BOE is the final produced oil equivalent of the production well before normalization, m³; Para, represents a horizontal section length, number of fracturing sections, number of fracturing clusters and supporting dose used per meter of the production well; Para_avᵢ, represents average values of the horizontal section length, the number of fracturing sections, the number of fracturing clusters and the supporting dose used per meter of the production well in the target layer of the research region, with dimension of quantity being the same as Paraᵢ.

In specific implementations, the established prediction models of the influencing parameters are as follows:

(1) EUR_BOE model is calculated by Ro.

A shale core sample in a target layer of a research region is collected, and preferably according to SY/T 5124-2012 industrial standard stipulated in Method for Measuring Vitrinite Reflectance in Sedimentary Rock, the vitrinite reflectance (Ro) of the shale core sample in the target layer of the research region is measured.

By utilizing normalized values of EUR_BOE for a production well in the target layer of the research region, EUR_BOE average values within certain Ro intervals are acquired in accordance with the intervals, and preferably EUR_BOE average values corresponding to Ro are acquired respectively at an interval that Ro is spaced by 0.1% , and an EUR_BOE prediction model is established (i.e., a prediction model (the following equation (6)) of the final produced oil equivalent corresponding to an organic matter maturity value, and the related diagram is shown in FIG. 5).

$${EUR\_BOE}_{Ro} = \{ \begin{matrix}{a}_{11} {Ro}^{2} + {a}_{12} Ro + {a}_{13} & Ro \leq 1.55 \% \\ {a}_{21} {Ro}^{2} + {a}_{22} Ro + {a}_{23} & 1.55 \% < Ro \leq 2.0 \% \\ {a}_{31} Ro + {a}_{32} & Ro > 2.0 \%\end{matrix} ; \qquad ( 6 )$$

in the equation, EUR_BOE_{Ro} is the final produced oil equivalent corresponding to an organic matter maturity value, 10⁴ m³; Ro is the vitrinite reflectance, %; a₁₁, a₁₂, a₁₃, a₂₁, a₂₂, a₂₃, a₃₁, a₃₂ are empirical parameters, which are −6.7598, 23.6416, −12.8583, 11.2286, −49.2073, 57.5043, −0.8715, 5.9172, respectively.

(2) EUR_BOE model is calculated by TOC.

A shale core sample in a target layer of a research region is collected, and preferably according to GB/T 19145-2003 national standards stipulated in Measurement of Total Organic Carbon in Sedimentary Rocks, a total organic carbon content (TOC) of the shale sample in the target layer of the research region is measured.

Logging data of the target layer in the research region is collected, the logging data is calibrated by the acquired TOC of the shale core sample, and a model 7 (the equation (7)) is used to acquire TOC of the target layer in the research region.

TOC=a₂×ρ+b₂; (7)

in the equation, TOC is the total organic carbon content, %; ρ is density logging value, g/cm³; a₂, b₂ are empirical parameters which are −0.226113, 0.601813, respectively.

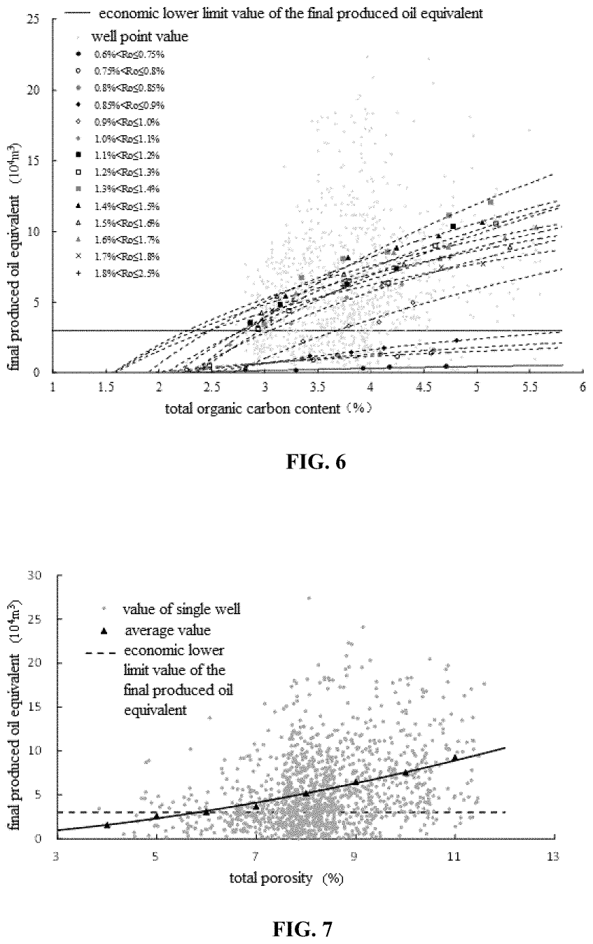

By utilizing the normalized value of EUR_BOE for a production well in the target layer of the research region, EUR_BOE average values within certain TOC intervals are acquired in accordance with the intervals, and preferably the EUR_BOE average values corresponding to TOC are acquired respectively at an interval that TOC is spaced by 1% , and an EUR_BOE prediction model is established (i.e., a prediction model (the following equation (8)) of the final produced oil equivalent corresponding to a total organic carbon content value, and the related diagram is shown in FIG. 6).

EUR_BOE_{TOC}=a₃In(TOC)+b₃; (8)

in the equation, EUR_BOE_{TOC} is the final produced oil equivalent corresponding to a total organic carbon content value, 10⁴ m³; TOC is the total organic carbon content, %; a₃, b₃ are empirical parameters that are shown in the following Table 1.

TABLE 1
Empirical parameters in the equation
EUR_BOE_{TOC} calculated utilizing TOC.

| Ro (%) | a₃ | b₃ |
|---|---|---|
| 0.6 < Ro ≤ 0.75 | 0.5800 | −0.4643 |
| 0.75 < Ro ≤ 0.8 | 1.6091 | −1.0596 |
| 0.8 < Ro ≤ 0.85 | 2.1673 | −1.6871 |
| 0.85 < Ro ≤ 0.9 | 3.3601 | −3.0131 |
| 0.9 < Ro ≤ 1.0 | 9.5720 | −9.4849 |
| 1.0 < Ro ≤ 1.1 | 10.0931 | −8.2653 |
| 1.1 < Ro ≤ 1.2 | 12.0410 | −9.2874 |
| 1.2 < Ro ≤ 1.3 | 12.9922 | −11.1223 |
| 1.3 < Ro ≤ 1.4 | 15.6564 | −13.2674 |
| 1.4 < Ro ≤ 1.5 | 10.9047 | −6.9428 |
| 1.5 < Ro ≤ 1.6 | 7.4681 | −3.3729 |
| 1.6 < Ro ≤ 1.7 | 8.0705 | −3.6159 |
| 1.7 < Ro ≤ 1.8 | 6.7347 | −3.1147 |
| 1.8 < Ro ≤ 2.5 | 9.9915 | −7.2409 |

(3) EUR_BOE model is calculated by ϕₜ.

A shale core sample in a target layer of a research region is collected, and preferably ϕₜ of the shale core sample is measured by a GRI method. Logging data of the target layer of the research region is collected, the logging data is calibrated by the acquired ϕₜ of the shale core sample, and a model 9 (the equation (9)) is used to acquire ϕₜ of the target layer in the research region.

φₜ=a₄×ρ+b₄; (9)

in the equation, ϕₜ is the total porosity, %; ρ is a density logging value, g/cm³; a₄, b₄ are empirical parameters that are −30.33649, 85.88745, respectively.

By utilizing the normalized value of EUR_BOE for a production well in the target layer of the research region, EUR_BOE average values within certain ϕₜ intervals are acquired in accordance with the intervals, and preferably the EUR_BOE average values corresponding to ϕₜ are acquired respectively at an interval that ϕₜ is spaced by 1% , and an EUR_BOE prediction model is established (i.e., a prediction model (the following equation (10)) of the final produced oil equivalent corresponding to a total porosity value, and the related diagram is shown in FIG. 7).

EUR_BOE_{φ}=a₅φₜ^{b}^{₅}; (10)

in the equation, EUR_BOE_{φ} is the final produced oil equivalent corresponding to a total porosity value, 10⁴ m³; ϕₜ the total porosity, %; a₅, b₅ are empirical parameters that are 0.1484, 1.7074, respectively.

(4) EUR_BOE model is calculated by He_{_Shale}:

Based on a TOC value of acquired logging interpretation, calculate to acquire thickness of a shale section where TOC is larger than a lower limit value TOC_{Cutoff}, and preferably TOC_{cutoff}=1.5%.

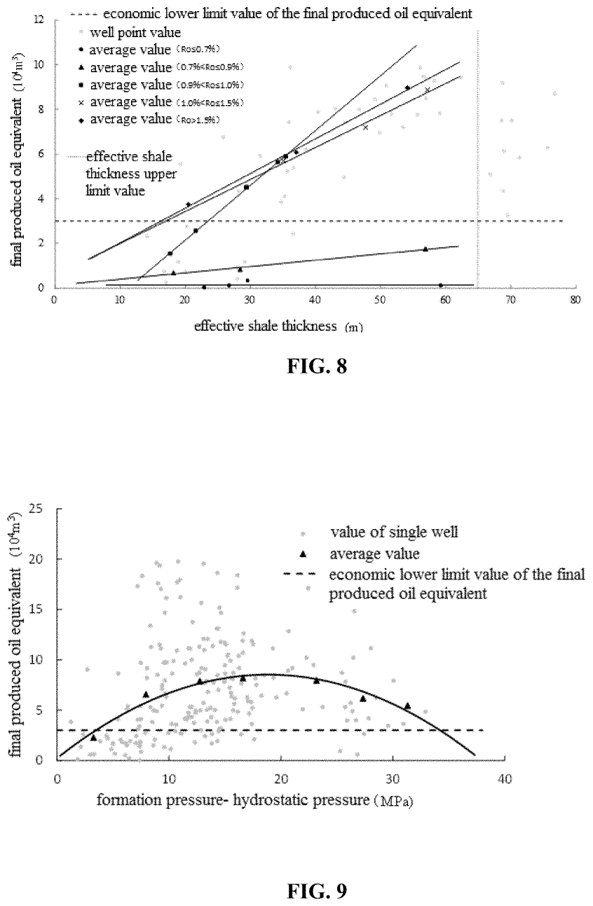

By utilizing the normalized values of EUR_BOE for a production well in the target layer of the research region, EUR_BOE average values within certain He_{_Shale} intervals are acquired in accordance with the intervals, and preferably the EUR_BOE average values corresponding to He_{_Shale} are acquired respectively at an interval that He_{_Shale} is spaced by 5 m, and an EUR_BOE prediction model is established (i.e., a prediction model (the following equation (11)) of the final produced oil equivalent corresponding to an effective shale thickness value, and the related diagram is shown in FIG. 8).

EUR_BOE_{He}=a₆He_{_Shale}+b₆; (11)

in the equation, EUR_BOE_{He} is the final produced oil equivalent corresponding to an effective shale thickness value, 10⁴ m₃; He_{_Shale} is the effective shale thickness, m; a₆, b₆ are empirical parameters that are 0.0282, 0.1093 respectively when 0.7%<Ro≤0.9%, and are 0.2453, -2.7574 respectively when 0.9%<Ro≤1.0%, and are 0.1554, 0.4699 respectively when 1.0%<Ro≤1.5%, and are 0.1430, 0.5731 respectively when Ro>1.5%.

There is an upper limit value for an effective shale thickness controlled by a single well, which is preferably 65 m according to the current status of a fracturing technology, that is, when the effective shale thickness is larger than 65 m, the final produced oil equivalent has nothing to do with the effective shale thickness.

(5) EUR_BOE model is calculated by ΔP_{F-S}:

Collecting test production data of a target layer in a research region and depth of the target layer, acquiring original formation pressure at the depth of the target layer, and acquiring ΔP_{F-S} by a difference between the original formation pressure and hydrostatic pressure.

By utilizing the normalized values of EUR_BOE for a production well in the target layer of the research region, EUR_BOE average values within certain ΔP_{F-S} intervals are acquired in accordance with the intervals, and preferably the EUR_BOE average values corresponding to ΔP_{F-S} are acquired respectively at an interval that ΔP_{F-S} is spaced by 5 m, and a EUR_BOE prediction model is established (i.e., a prediction model (the following equation (12)) of the final produced oil equivalent corresponding to an original formation pressure value, and the related diagram is shown in FIG. 9).

EUR_BOE shows a tendency of firstly increasing and then decreasing with the increase of ΔP_{F-S}, a calculation model for EUR_BOE is as follows.

EUR_BOE_{P}=c₁ΔP_{F-S}²+c₂ΔP_{F-S}+c₃; (12)

in the equation, EUR_BOE_{P} is the final produced oil equivalent corresponding to an original formation pressure value, 10⁴ m³; ΔP_{F-S} is the difference between the original formation pressure and the hydrostatic pressure, MPa; c₁, c₂, c₃ are empirical parameters that are −0.0234, 0.8807, 0.2241, respectively.

(6) EUR_BOE model is calculated by V_{clay},

A shale core sample in a target layer of a research region is collected, and preferably according to SY/T 51630-1995 Oil and Gas Industry Standard stipulated in Method for Analyzing X Diffraction of Relative Content of Minerals in Sedimentary Clay, the clay content (V_{clay}) of the shale sample in the target layer of the research region is measured.

Logging data of the target layer in the research region is collected, the logging data is calibrated by the acquired V_{clay} of the shale core sample, and a model 13 is used to acquire V_{clay} of the target layer in the research region.

V_{Clay}=a₇+b₇×GR+c₇×CNL; (13)

in the equation, V_{clay} is clay volume content, %; GR is a natural gamma logging value, API; CNL is a neutron logging value, %; a₇, b₇, c₇ are empirical parameters that are 1.02484, −0.0047615, −0.635518, respectively.

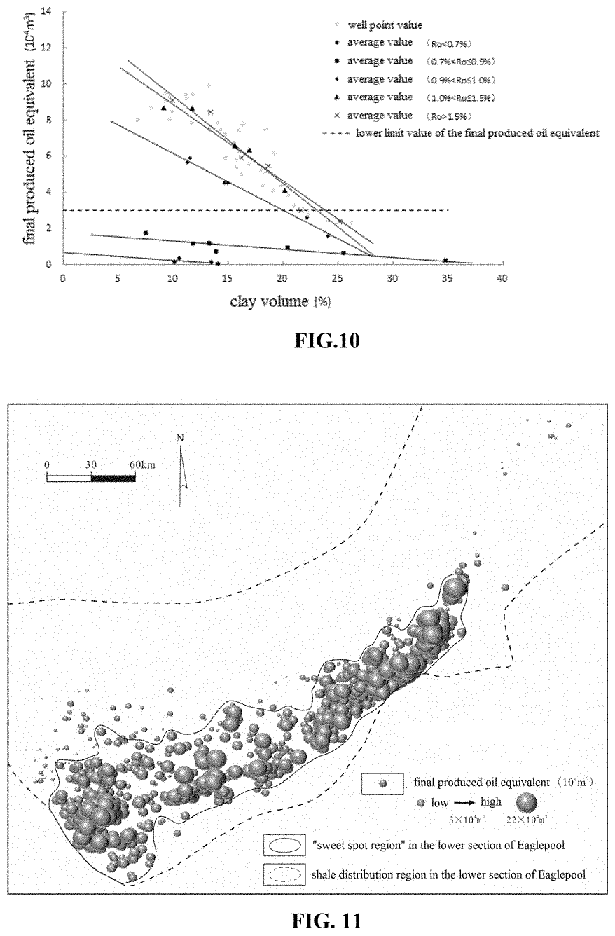

By utilizing the normalized values of EUR_BOE for a production well in the target layer of the research region, EUR_BOE average values within certain V_{clay} intervals are acquired in accordance with the intervals, and preferably the EUR_BOE average values corresponding to V_{clay} are acquired respectively by an interval that V_{clay} is spaced by 5% , and the EUR_BOE prediction model is established (i.e., a prediction model (the following equation (14)) of the final produced oil equivalent corresponding to a clay volume content, and the related diagram is shown in FIG. 10).

EUR_BOE_{V}=a₈V_{clay}+b₈; (14)

in the equation, EUR_BOE_{V} is the final produced oil equivalent corresponding to the clay volume content, 10⁴ m³; V_{clay} is the clay volume content, %; a₈, b₈ are empirical parameters which are −0.0458, 1.7608 respectively when 0.7%<Ro≤0.9%, and are −0.3145, 9.2836 respectively when 0.9%<Ro≤1.0%, and are −0.4234, 13.0841 when 1.0%<Ro≤1.5%, and are −0.4841, 14.1748 when Ro>1.5%.

II. Secondly, the process of regionally dividing the research region and predicting a sweet spot region for each region (shale oil and gas region to be predicted) (i.e. the process of determining whether the divided shale oil and gas region to be predicted is a sweet spot region) is introduced.

1. Firstly, dividing an evaluation region (shale oil and gas region to be predicted) according to a distribution range of the target layer in the research region:

In specific implementations, the evaluation region is divided based on parameter distribution of the target layer in the research region. The divided evaluation region range of the marine sedimentary stratum is preferably 5 km×5 km, the divided evaluation region range of the land sedimentary stratum is preferably 3 km×3 km, and variation range of Ro within the evaluation region is smaller than a certain value, preferably 0.1%.

2. Secondly, acquiring an evaluation parameter within the evaluation region (i.e., acquiring an oil and gas content influencing parameter value, an oil and gas fluidity influencing parameter value and a compressibility influencing parameter value of a shale target layer in a shale oil and gas region to be predicted), then calculating and obtaining EUR_BOE of the evaluation region (i.e., determining a final produced oil equivalent corresponding to each influencing parameter value according to the oil and gas content influencing parameter value, the oil and gas fluidity influencing parameter value and the compressibility influencing parameter value, and a pre-established final produced oil equivalent prediction model):

In one embodiment, the final produced oil equivalent corresponding to an organic matter maturity value may be determined according to the following equation (i.e., the above equation (1)):

$${EUR\_BOE}_{Ro} = \{ \begin{matrix}{a}_{11} {Ro}^{2} + {a}_{12} Ro + {a}_{13} & Ro \leq 1.55 \% \\ {a}_{21} {Ro}^{2} + {a}_{22} Ro + {a}_{23} & 1.55 \% < Ro \leq 2.0 \% \\ {a}_{31} Ro + {a}_{32} & Ro > 2.0 \%\end{matrix} ;$$

wherein, EUR_BOE_{Ro} is the final produced oil equivalent corresponding to an organic matter maturity value; Ro is the vitrinite reflectance; a₁₁, a₁₂, a₁₃, a₂₁, a₂₂, a₂₃, a₃₁, a₃₂ are empirical parameters.

In one embodiment, the final produced oil equivalent corresponding to a total organic carbon content value may be determined according to the following equation (i.e., the above equation (2)):

EUR_BOE_{TOC}=a₃In(TOC)+b₃ ;

wherein, EUR_BOE_{TOC} is the final produced oil equivalent corresponding to a total organic carbon content value; a₃, b₃ are empirical parameters; TOC is the total organic carbon content, TOC=a₂×ρ+b₂, p is a density logging value, a₂, b₂ are empirical parameters.

In one embodiment, the final produced oil equivalent corresponding to a total porosity value may be determined according to the following equation (i.e., the above equation (3)):

EUR_BOE_{φ}=a₅φₜ^{b}^{₅};

wherein, EUR_BOE_{φ} is the final produced oil equivalent corresponding to a total porosity value; a₅, b₅ are empirical parameters; ϕₜ is the total porosity, φᵢ=a₄×ρ+b₄ , ρ is a density logging value; a₄, b₄ are empirical parameters.

In one embodiment, the final produced oil equivalent corresponding to an effective shale thickness value may be determined according to the following equation (i.e., the above equation (4)):

EUR_BOE_{He}=a₆He_{_Shale}+b₆;

wherein, EUR_BOE_{He} is the final produced oil equivalent corresponding to an effective shale thickness value; a₆, b₆ are empirical parameters; He_{_Shale} is the effective shale thickness.

In one embodiment, the final produced oil equivalent corresponding to an original formation pressure value may be determined according to the following equation (i.e., the above equation (5)):

EUR_BOE_{P}=c₁ΔP_{F-S}²+c₂ΔP_{F-S}+c₃;

EUR_BOE_{P} is the final produced oil equivalent corresponding to an original formation pressure value; ΔP_{F-S} is a difference between the original formation pressure and hydrostatic pressure; c₁, c₂, c₃ are empirical parameters.

In one embodiment, the final produced oil equivalent corresponding to a clay volume content value may be determined according to the following equation (i.e., the above equation (6)):

EUR_BOE_{V}=a₈V_{clay}+b₈;

wherein, EUR_BOE_{V} is the final produced oil equivalent; a₈, b₈ are empirical parameters; V_{clay} is the clay volume content, V_{clay}=a₇+b₇×GR+c₇×CNL, GR is a natural gamma logging value, CNL is a neutron logging value, a₇, b₇, c₇ are empirical parameters.

3. Acquiring an economic lower limit value EUR_BOE_{cutoff} of the final produced oil equivalent EUR_BOE (i.e., determining an economic lower limit value of the final produced oil equivalent for the shale oil and gas region to be predicted, according to the production cost data):

In specific implementations, production cost data are collected, such as fixed investment, operating cost, tax, waste cost, oil equivalent price and other parameters for development of the target layer of the research region, a model 15 (the following equation (15)) is used for acquiring EUR_BOE_{cutoff}.

EUR_BOE_{cutoff}=(Capexᵢ+Opexᵢ+Taxᵢ+Dctᵢ)/P_{BOE}; (15)

EUR_BOE_{cutoff} is the economic lower limit value of the final produced oil equivalent of the target layer in the research region, 10⁴ m³; Capexᵢ is an average value of the fixed investment for a single well, tens of thousands yuan; Opexᵢ is an average value of the operating cost for a single well before being abandoned, tens of thousands yuan; Taxᵢ is tax of the produced oil and gas, tens of thousands yuan; Dctᵢis an average value of the abandoned investment for a signal well, tens of thousands yuan; P_{BOE} is price of the produced oil equivalent, tens of thousands yuan/10⁴ m³.

EUR_BOE_{cutoff} is determined based on oil equivalent price, fixed investment, operating cost, tax, abandonment and etc., EUR_BOE_{cutoff} differs in different evaluation regions, and preferably EUR_BOE_{cutoff} is 3×10⁴ m³.

4. Obtaining an index SW_{index} of a “sweet spot region”, and acquiring distribution range of the “sweet spot region” based on the evaluation standard that is SW_{index}≥1 (i.e., determining whether or not the shale oil and gas region to be predicted is a shale oil and gas sweet spot region according to the final produced oil equivalent corresponding to each influencing parameter value and the economic lower limit value of the final produced oil equivalent):

In one embodiment, determining whether or not the shale oil and gas region to be predicted is a shale oil and gas sweet spot region according to the final produced oil equivalent corresponding to each influencing parameter value and the economic lower limit value of the final produced oil equivalent of the shale oil and gas region to be predicted, may include:

determining that the shale oil and gas region to be predicted is a shale oil and gas sweet spot region when a ratio of the final produced oil equivalent corresponding to each influencing parameter value to the economic lower limit value of the final produced oil equivalent of the shale oil and gas region to be predicted is larger than or equal to 1;

determining that the shale oil and gas region to be predicted is not a shale oil and gas sweet spot region when the ratio of the final produced oil equivalent corresponding to each influencing parameter value to the economic lower limit value of the final produced oil equivalent of the shale oil and gas region to be predicted is smaller than 1.

In specific implementations, the above described “ratio” may be referred to an index SW_{index} of a “sweet spot region”, and the index SW_{index} of the “sweet spot region” can be determined in accordance with the following equation (16):

$${SW}_{index} = {\prod }_{i} \frac{{EUR\_BOE}_{i}}{{EUR\_BOE}_{cutoff}} ; \qquad ( 16 )$$

in the equation, SW_{index} is the index of the “sweet spot region”, and is dimensionless; EUR_BOEᵢ are EUR_BOE obtained utilizing calculation models of TOC, Ro, φₜ, He_{_Shale}, ΔP_{F-S} , V_{Caly} respectively; EUR_BOE_{cutoff} is the economic lower limit value of the final produced oil equivalent EUR_BOE in the research region.

Based on the acquired SW_{index}, distribution region of the “sweet spot region” is acquired according to the evaluation standard that is SW_{index}≥1.

Accordingly, in the embodiment of the present invention, based on the economic lower limit value of the final produced oil equivalent together with the final produced oil equivalents predicted by six independent parameters, an index of the “sweet spot region” is established uniformly, and a preferable “sweet spot region” is evaluated by the index of a “sweet spot region”.

In specific implementations, it can be determined according to oil price, fixed investment, operating cost, tax, reclamation and environmental protection cost, sinking cost and etc. that the oil equivalent is preferably 3×10⁴ m³.

In specific implementations, the above equations (15) and (16) may also be established in advance.

The embodiment of the present invention provides a technology of evaluating a preferable “sweet spot region” for exploration and development of shale oil and gas, to support exploration and development of the shale oil and gas.

FIG. 11 is a distribution diagram of “sweet spot region” of shale oil and gas in the lower section of Eaglepool that is obtained by the technical solution provided in the embodiment of the present invention, and it can be seen that the distribution range of “sweet spot region” is obviously smaller than the range of a shale distribution region. In the range of “sweet spot region”, although EUR_BOE of part of wells is smaller than EUR_BOE_{cutoff} of the region, the average EUR_BOE of production wells in the evaluation region is greater than EUR_BOE_{cutoff}.

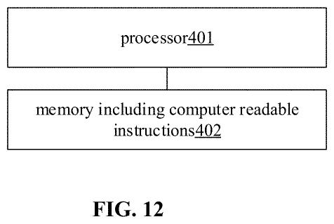

The embodiment of the present invention further provides a computer device, as shown in FIG. 12, the computer device comprises: a processor 401 and a memory 402 including computer readable instructions, wherein, the memory 402 is coupled to the processor 401, when being executed, the computer readable instructions cause the processor to execute the following operations:

acquiring an oil and gas content influencing parameter value, an oil and gas fluidity influencing parameter value and a compressibility influencing parameter value of a shale target layer in a shale oil and gas region to be predicted, and production cost data;

determining a final produced oil equivalent corresponding to each influencing parameter value according to the oil and gas content influencing parameter value, the oil and gas fluidity influencing parameter value and the compressibility influencing parameter value, and a pre-established final produced oil equivalent prediction model;

determining an economic lower limit value of the final produced oil equivalent of the shale oil and gas region to be predicted, according to the production cost data;

determining whether or not the shale oil and gas region to be predicted is a shale oil and gas sweet spot region according to the final produced oil equivalent corresponding to each influencing parameter value and the economic lower limit value of the final produced oil equivalent of the shale oil and gas region to be predicted.

In one embodiment, the oil and gas content influencing parameter includes a total organic carbon content, a maturity of organic matter, and an effective shale thickness; the oil and gas fluidity influencing parameter includes a total porosity of shale and an original formation pressure; the compressibility influencing parameter includes a clay volume content.

In one embodiment, the above computer readable instructions cause the processor to establish the final produced oil equivalent prediction model by the following method of:

obtaining oil and gas production data of a shale section production well in a target layer of a research region, as well as an oil and gas content influencing parameter value, an oil and gas fluidity influencing parameter value and a compressibility influencing parameter value of the target layer in the research region;

predicting a final produced oil equivalent of the shale section production well in the target layer of the research region according to the oil and gas production data within a preset time period;

normalizing a horizontal section length, number of fracturing sections, number of fracturing clusters and supporting dose used per meter of the final produced oil equivalent of the production well in the target layer of the research region;

acquiring an average value of the final produced oil equivalent within a preset interval of an influencing parameter value according to the interval by using the normalized values of the final produced oil equivalent of the production well in the target layer of the research region, and establishing a final produced oil equivalent prediction model corresponding to each influencing parameter value.

In one embodiment, the above computer readable instructions cause the processor to:

establish a monthly oil and gas production prediction model of the production well according to data of oil production equivalent of the production well in 4 months near the 180th day;

determine an oil equivalent economic lower limit value of the production well according to the monthly oil and gas production prediction model and production cost data;

determine a final produced oil equivalent of the production well according to the oil equivalent economic lower limit value of the production well and oil and gas production of the production well in all previous months.

In one embodiment, the above computer readable instructions cause the processor to determine the final produced oil equivalent corresponding to an organic matter maturity value in accordance with the following equation:

$${EUR\_BOE}_{Ro} = \{ \begin{matrix}{a}_{11} {Ro}^{2} + {a}_{12} Ro + {a}_{13} & Ro \leq 1.55 \% \\ {a}_{21} {Ro}^{2} + {a}_{22} Ro + {a}_{23} & 1.55 \% < Ro \leq 2.0 \% \\ {a}_{31} Ro + {a}_{32} & Ro > 2.0 \%\end{matrix} ;$$

wherein, EUR_BOE_{Ro} is the final produced oil equivalent corresponding to an organic matter maturity value; Ro is the vitrinite reflectance; a₁₁, a₁₂ , a₁₃, a₂₁, a₂₂ , a₂₃, a₃₁, a₃₂ are empirical parameters.

In one embodiment, the above computer readable instructions cause the processor to determine the final produced oil equivalent corresponding to a total organic carbon content value in accordance with the following equation:

EUR_BOE_{TOC}=a₃In(TOC)+b₃ ;

wherein, EUR_BOE_{TOC} is the final produced oil equivalent corresponding to a total organic carbon content value; a₃, b₃ are empirical parameters; TOC is the total organic carbon content, TOC=a₂×ρ+b₂, p is a density logging value, a₂, b₂ are empirical parameters.

In one embodiment, the above computer readable instructions cause the processor to determine the final produced oil equivalent corresponding to a total porosity value in accordance with the following equation:

EUR_BOE_{φ}=a₅φₜ^{b}^{₅};

wherein, EUR_BOE_{φ} is the final produced oil equivalent corresponding to a total porosity value; a₅, b₅ are empirical parameters; ϕₜ is the total porosity, φₜ=a₄×ρ+b₄, ρ is a density logging value; a₄, b₄ are empirical parameters.

In one embodiment, the above computer readable instructions cause the processor to determine the final produced oil equivalent corresponding to an effective shale thickness value in accordance with the following equation:

EUR_BOE_{He}=a₆He_{_Shale}+b₆;

wherein, EUR_BOE_{He} is the final produced oil equivalent corresponding to an effective shale thickness value; a₆, b₆ are empirical parameters; He_{_Shale} is the effective shale thickness.

In one embodiment, the above computer readable instructions cause the processor to determine the final produced oil equivalent corresponding to an original formation pressure value in accordance with the following equation:

EUR_BOE_{P}=c₁ΔP_{F-S}²+c₂ΔP_{F-S}+c₃;

EUR_BOE is the final produced oil equivalent corresponding to an original formation pressure value; ΔP_{F-S} is a difference between the original formation pressure and hydrostatic pressure; c₁, c₂, c₃ are empirical parameters.

In one embodiment, the above computer readable instructions cause the processor to determine the final produced oil equivalent corresponding to a clay volume content value in accordance with the following equation:

EUR_BOE_{V}=a₈V_{clay}+b₈;

wherein, EUR_BOE_{V} is the final produced oil equivalent corresponding to a clay volume content value; a₈, b₈, are empirical parameters; V_{clay} is the clay volume content, V_{Clay}=a₇+b₇×GR+c₇×CNL, GR is a natural gamma logging value, CNL is a neutron logging value, a₇, b₇, c₇ are empirical parameters.

The embodiment of the invention further provides a computer readable storage medium including computer readable instructions, when being executed, the computer readable instructions cause a processor to execute at least the following operations:

acquiring an oil and gas content influencing parameter value, an oil and gas fluidity influencing parameter value and a compressibility influencing parameter value of a shale target layer in a shale oil and gas region to be predicted, and production cost data;

determining a final produced oil equivalent corresponding to each influencing parameter value according to the oil and gas content influencing parameter value, the oil and gas fluidity influencing parameter value and the compressibility influencing parameter value, and a pre-established final produced oil equivalent prediction model;

determining an economic lower limit value of the final produced oil equivalent of the shale oil and gas region to be predicted, according to the production cost data;

determining whether or not the shale oil and gas region to be predicted is a shale oil and gas sweet spot region according to the final produced oil equivalent corresponding to each influencing parameter value and the economic lower limit value of the final produced oil equivalent of the shale oil and gas region to be predicted.

In one embodiment, the above described oil and gas content influencing parameter includes a total organic carbon content, a maturity of organic matter, and an effective shale thickness; the above described oil and gas fluidity influencing parameter includes a total porosity of shale and an original formation pressure; the above described compressibility influencing parameter includes a clay volume content.

In one embodiment, the computer readable instructions cause the processor to establish the final produced oil equivalent prediction model by the following method of:

obtaining oil and gas production data of a shale section production well in a target layer of a research region, as well as an oil and gas content influencing parameter value, an oil and gas fluidity influencing parameter value and a compressibility influencing parameter value of the target layer in the research region;

predicting a final produced oil equivalent of the shale section production well in the target layer of the research region according to the oil and gas production data within a preset time period;

normalizing a horizontal section length, number of fracturing sections, number of fracturing clusters and supporting dose used per meter of the final produced oil equivalent of the production well in the target layer of the research region;

acquiring an average value of the final produced oil equivalent within a preset interval of an influencing parameter value according to the interval by using the normalized values of the final produced oil equivalent of the production well in the target layer in the research region, and establishing a final produced oil equivalent prediction model corresponding to each influencing parameter value.

In one embodiment, the above computer readable instructions cause the processor to:

establish a monthly oil and gas production prediction model of the production well according to data of oil production equivalent of the production well in 4 months near the 180th day;

determine an oil equivalent economic lower limit value of the production well according to the monthly oil and gas production prediction model and production cost data;

determine a final produced oil equivalent of the production well according to the oil equivalent economic lower limit value of the production well and oil and gas production of the production well in all previous months.

In one embodiment, the above computer readable instructions cause the processor to determine the final produced oil equivalent corresponding to an organic matter maturity value in accordance with the following equation:

$${EUR\_BOE}_{Ro} = \{ \begin{matrix}{a}_{11} {Ro}^{2} + {a}_{12} Ro + {a}_{13} & Ro \leq 1.55 \% \\ {a}_{21} {Ro}^{2} + {a}_{22} Ro + {a}_{23} & 1.55 \% < Ro \leq 2.0 \% \\ {a}_{31} Ro + {a}_{32} & Ro > 2.0 \%\end{matrix} ;$$

wherein, EUR_BOE_{Ro} is the final produced oil equivalent corresponding to an organic matter maturity value; Ro is the vitrinite reflectance; a₁₁, a₁₂, a₁₃, a₂₁, a₂₂ , a₂₃, a₃₁, a₃₂ are empirical parameters.

In one embodiment, the above computer readable instructions cause the processor to determine the final produced oil equivalent corresponding to a total organic carbon content value in accordance with the following equation:

EUR_BOE_{TOC}=a₃In(TOC)+b₃;

wherein, EUR_BOE_{TOC} is the final produced oil equivalent corresponding to a total organic carbon content value; a₃, b₃ are empirical parameters; TOC is the total organic carbon content, TOC=a₂×ρ+b₂, ρ is a density logging value, a₂ , b₂ are empirical parameters.

In one embodiment, the above computer readable instructions cause the processor to determine final produced oil equivalent corresponding to a total porosity value in accordance with the following equation:

EUR_BOE_{φ}=a₅φₜ^{b}^{₅};

wherein, EUR_BOE_{φ} is the final produced oil equivalent corresponding to a total porosity value; a₅, b₅ are empirical parameters; ϕₜ is the total porosity, φₜ=a₄×ρ+b₄, ρ is a density logging value; a₄, b₄ are empirical parameters.

In one embodiment, the above computer readable instructions cause the processor to determine the final produced oil equivalent corresponding to an effective shale thickness value in accordance with the following equation:

EUR_BOE_{He}=a₆He_{_Shale}+b₆;

wherein, EUR_BOE_{He} is the final produced oil equivalent corresponding to an effective shale thickness value; a₆, b₆ are empirical parameters; He_{_Shale} is the effective shale thickness.

In one embodiment, the above computer readable instructions cause the processor to determine the final produced oil equivalent corresponding to an original formation pressure value in accordance with the following equation:

EUR_BOE_{P}=c₁ΔP_{F-S}²+c₂ΔP_{F-S}+c₃;

EUR_BOE_{P} is the final produced oil equivalent corresponding to an original formation pressure value; ΔP_{F-S} is a difference between the original formation pressure and hydrostatic pressure; c₁, c₂, c₃ are empirical parameters.

In one embodiment, the above computer readable instructions cause the processor to determine the final produced oil equivalent corresponding to a clay volume content value in accordance with the following equation:

EUR_BOE_{V}=a₈V_{clay}+b₈;

wherein, EUR_BOE_{V} is the final produced oil equivalent corresponding to a clay volume content value; a₈, b₈ are empirical parameters; V_{clay} is the clay volume content, V_{Clay}=a₇+b₇×GR+c₇×CNL, GR is a natural gamma logging value, CNL is a neutron logging value, a₇, b₇, c₇ are empirical parameters.

In one embodiment, the above computer readable instructions cause the processor to determine the economic lower limit value of the final produced oil equivalent in accordance with the following equation:

EUR_BOE_{cutoff}=(Capexᵢ+Opexᵢ+Taxᵢ+Dctᵢ)/P_{BOE};

wherein, EUR_BOE_{cutoff} is the economic lower limit value of the final produced oil equivalent of the shale target layer in a shale oil and gas region to be predicted; Capexᵢ is an average value of the fixed investment for a single well; Opexᵢ is an average value of the operating cost for a single well before being abandoned; Taxᵢ is tax of the produced oil and gas; Dctᵢ is an average value of the abandoned investment for a signal well; P_{BOE} is price of the produced oil equivalent.

In one embodiment, the above computer readable instructions cause the processor to determine an index of a sweet spot region in accordance with the following equation:

$${SW}_{index} = {\prod }_{i} \frac{{EUR\_BOE}_{i}}{{EUR\_BOE}_{cutoff}} ;$$

wherein, SW_{index} is the index of the sweet spot region; EUR_BOEᵢ are the final produced oil equivalent determined by the final produced oil equivalent corresponding to each influencing parameter value; EUR_BOE_{cutoff} is the economic lower limit value of the final produced oil equivalent of the shale target layer in a shale oil and gas region to be predicted;

when SW_{index}≥1, the shale oil and gas region to be predicted is a shale oil and gas sweet spot region.

The advantageous technical effects of the technical solution provided by the implementations of the present invention are as follows:

The technical solution provided by the embodiment of the present invention gives a method technology for evaluating (predicting) a preferable shale oil and gas “sweet spot region”, provides a means for evaluating a preferable shale oil and gas “sweet spot region”, solves defects and deficiencies in current evaluation for a preferable shale oil and gas “sweet spot region”, improves precision of evaluation for a preferable “sweet spot region” and can meet the demand of exploration and development of the shale oil and gas. The inventor invents a method for determining and acquiring a final produced oil equivalent model by utilizing monthly oil and gas production data of a shale oil and gas production well during production time near the 180th day, thereby improving the prediction accuracy effectively. Six independent parameters that are oil and gas content, oil and gas fluidity and shale compressibility are preferred, and a relationship model with the final produced oil equivalent is established, which causes the control effect of the independent parameters on the final produced oil equivalent to truly reappear, eliminates the problem that mutual influence of multiple parameters in the prior art results in low prediction accuracy. The horizontal section length, the number of fracturing sections, the number of fracturing clusters and the supporting dose used per meter are used to normalize the final produced oil equivalent, and in addition, a method of acquiring the average value of the final produced oil equivalent within respective certain intervals of six independent parameters eliminates the difference of the final produced oil equivalent that is caused by engineer factors, and evaluation of a geological “sweet spot region” is truly realized. It is proposed that based on the economic lower limit value of the final produced oil equivalent together with the final produced oil equivalents predicted by six independent parameters, an index of the “sweet spot region” is established uniformly, and a preferable “sweet spot region” is evaluated by the index of the “sweet spot region”. A method for regionally evaluating the target layer in the research region is adopted, and a regional principle is given, which overcomes the problem of great difficulty of predicting the final produced oil equivalent of a single well in the actual exploration and development, and truly achieves evaluation of a “sweet spot region”.

In conclusion, the technical solution provided by the embodiment of the present invention realizes quantitative prediction of a shale oil and gas sweet spot region, improves the accuracy of prediction of the shale oil and gas sweet spot region, and provides scientific guidance for shale oil and gas exploration and development.

It will be apparent to those skilled in the art that the modules or steps of the embodiment of the invention described above may be implemented with a generic computing apparatus, which may be integrated on a single computing apparatus, or distributed over a network formed by multiple computing apparatuses, which may alternatively be implemented with program codes executable by the computing apparatus, so that they may be stored in a storage apparatus to be executed by the computing apparatus, and in some cases, the steps shown or described may be performed in a different order than that is given herein, or they may be separately fabricated as individual integrated circuit modules, or multiple modules or steps thereof may be implemented as a single integrated circuit module. Thus, the embodiment of the present invention is not limited to any particular combination of hardware and software.

The foregoing is merely a preferred embodiment of the present invention and is not intended to limit the present invention, and various modifications and variations can be made to the embodiment of the present invention by those skilled in the art. Any modifications, equivalents, improvements, etc. made within the spirit and principle of the present invention are intended to be included within the protection scope of the present invention.

1. A prediction method for a shale oil and gas sweet spot region, comprising:
acquiring an oil and gas content influencing parameter value, an oil and gas fluidity influencing parameter value and a compressibility influencing parameter value of a shale target layer in a shale oil and gas region to be predicted, and production cost data;
determining a final produced oil equivalent corresponding to each influencing parameter value according to the oil and gas content influencing parameter value, the oil and gas fluidity influencing parameter value and the compressibility influencing parameter value, and a pre-established final produced oil equivalent prediction model;
determining an economic lower limit value of the final produced oil equivalent of the shale oil and gas region to be predicted, according to the production cost data;
determining whether or not the shale oil and gas region to be predicted is a shale oil and gas sweet spot region according to the final produced oil equivalent corresponding to each influencing parameter value and the economic lower limit value of the final produced oil equivalent of the shale oil and gas region to be predicted.

2. The prediction method for a shale oil and gas sweet spot region according to claim 1, wherein the oil and gas content influencing parameter includes a total organic carbon content, a maturity of organic matter, and an effective shale thickness; the oil and gas fluidity influencing parameter includes a total porosity of shale and an original formation pressure;
the compressibility influencing parameter includes a clay volume content.

3. The prediction method for a shale oil and gas sweet spot region according to claim 1, wherein the final produced oil equivalent prediction model is established by the following method of:
obtaining oil and gas production data of a shale section production well in a target layer of a research region, as well as an oil and gas content influencing parameter value, an oil and gas fluidity influencing parameter value and a compressibility influencing parameter value of the target layer in the research region;
predicting a final produced oil equivalent of the shale section production well in the target layer of the research region according to the oil and gas production data within a preset time period;
normalizing a horizontal section length, number of fracturing sections, number of fracturing clusters and supporting dose used per meter of the final produced oil equivalent of the production well in the target layer of the research region;
acquiring an average value of the final produced oil equivalent within a preset interval of an influencing parameter value according to the interval by using the normalized values of the final produced oil equivalent of the production well in the target layer of the research region, and establishing a final produced oil equivalent prediction model corresponding to each influencing parameter value.

4. The prediction method for a shale oil and gas sweet spot region according to claim 3, wherein predicting a final produced oil equivalent of the shale section production well in the target layer of the research region according to the oil and gas production data within a preset time period, includes:
establish a monthly oil and gas production prediction model of the production well according to data of oil production equivalent of the production well in 4 months near the 180th day;
determine an oil equivalent economic lower limit value of the production well according to the monthly oil and gas production prediction model and production cost data;
determine a final produced oil equivalent of the production well according to the oil equivalent economic lower limit value of the production well and oil and gas production of the production well in all previous months.

5. The prediction method for a shale oil and gas sweet spot region according to claim 2, wherein the final produced oil equivalent corresponding to an organic matter maturity value is determined in accordance with the following equation:
$${EUR\_BOE}_{Ro} = \{ \begin{matrix}{a}_{11} {Ro}^{2} + {a}_{12} Ro + {a}_{13} & Ro \leq 1.55 \% \\ {a}_{21} {Ro}^{2} + {a}_{22} Ro + {a}_{23} & 1.55 \% < Ro \leq 2.0 \% \\ {a}_{31} Ro + {a}_{32} & Ro > 2.0 \%\end{matrix} ;$$
wherein, EUR_BOE_{Ro} is the final produced oil equivalent corresponding to an organic matter maturity value; Ro is the vitrinite reflectance; a₁₁, a₁₂, a₁₃, a₂₁, a₂₂ , a₂₃, a₃₁, a₃₂ are empirical parameters.

6. The prediction method for a shale oil and gas sweet spot region according to claim 2, wherein the final produced oil equivalent corresponding to a total organic carbon content value is determined in accordance with the following equation:
EUR_BOE_{TOC}=a₃In(TOC)+b ₃;
wherein, EUR_BOE_{TOC} is the final produced oil equivalent corresponding to a total organic carbon content value; a₃, b₃ are empirical parameters; TOC is the total organic carbon content, TOC=a₂×ρ+b₂, ρ is a density logging value, a₂, b₂ are empirical parameters.

7. The prediction method for a shale oil and gas sweet spot region according to claim 2, wherein the final produced oil equivalent corresponding to a total porosity value is determined in accordance with the following equation:
EUR_BOE_{φ}=a₅φₜ^{b}^{₅};
wherein, EUR_BOE_{φ} is the final produced oil equivalent corresponding to a total porosity value; a₅, b₅ are empirical parameters; ϕₜ is the total porosity, φₜ=a₄×ρ+b₄, ρ is a density logging value; a₄, b₄ are empirical parameters.

8. The prediction method for a shale oil and gas sweet spot region according to claim 2, wherein the final produced oil equivalent corresponding to an effective shale thickness value is determined in accordance with the following equation:
EUR_BOE_{He}=a₆He_{_Shale}+b₆;
wherein, EUR_BOE_{He} is the final produced oil equivalent corresponding to an effective shale thickness value; a₆, b₆ are empirical parameters; He_{_Shale} is the effective shale thickness.

9. The prediction method for a shale oil and gas sweet spot region according to claim 2, wherein the final produced oil equivalent corresponding to an original formation pressure value is determined in accordance with the following equation:
EUR_BOE_{P}=c₁ΔP_{F-S}²+c₂ΔP_{F-S}+c₃;
EUR_BOE_{P} is the final produced oil equivalent corresponding to an original formation pressure value; ΔP_{F-S} is a difference between the original formation pressure and hydrostatic pressure; c₁, c₂, c₃ are empirical parameters.

10. The prediction method for a shale oil and gas sweet spot region according to claim 2, wherein the final produced oil equivalent corresponding to a clay volume content value is determined in accordance with the following equation:
EUR_BOE_{V}=a₈V_{clay}+b₈;
wherein, EUR_BOE_{V} is the final produced oil equivalent corresponding to a clay volume content value; a₈, b₈ are empirical parameters; V_{clay}, is the clay volume content, V_{Clay}=a₇+b₇×GR+c₇×CNL, GR is a natural gamma logging value, CNL is a neutron logging value, a₇, b₇, c₇ are empirical parameters.

11. The prediction method for a shale oil and gas sweet spot region according to claim 1, wherein the economic lower limit value of the final produced oil equivalent is determined in accordance with the following equation:
EUR_BOE_{cutoff}=(Capexᵢ+Opexᵢ+Taxᵢ+Dctᵢ)/P_{BOE}
wherein, EUR_BOE_{cutoff} is the economic lower limit value of the final produced oil equivalent of the shale target layer in a shale oil and gas region to be predicted; Capexᵢ is an average value of the fixed investment for a single well; Opexᵢ is an average value of the operating cost for a single well before being abandoned; Taxᵢ is tax of the produced oil and gas; Dctᵢ is an average value of the abandoned investment for a signal well; P_{BOE} is price of the produced oil equivalent.

12. The prediction method for a shale oil and gas sweet spot region according to claim 1, wherein determining whether or not the shale oil and gas region to be predicted is a shale oil and gas sweet spot region according to the final produced oil equivalent corresponding to each influencing parameter value and the economic lower limit value of the final produced oil equivalent of the shale oil and gas region to be predicted, includes:
an index of a sweet spot region is determined in accordance with the following equation:
$${SW}_{index} = {\prod }_{i} \frac{{EUR\_BOE}_{i}}{{EUR\_BOE}_{cutoff}} ;$$
wherein, SW_{index} is the index of the sweet spot region; EUR_BOEᵢ are the final produced oil equivalent determined by the final produced oil equivalent corresponding to each influencing parameter value; EUR_BOE_{cutoff} is the economic lower limit value of the final produced oil equivalent of the shale target layer in a shale oil and gas region to be predicted;
when SW_{index}≥1, the shale oil and gas region to be predicted is a shale oil and gas sweet spot region.

13. A computer device, characterized in comprising a processor and a memory including computer readable instructions, when being executed, the computer readable instructions cause the processor to execute the following operations:
acquiring an oil and gas content influencing parameter value, an oil and gas fluidity influencing parameter value and a compressibility influencing parameter value of a shale target layer in a shale oil and gas region to be predicted, and production cost data;
determining a final produced oil equivalent corresponding to each influencing parameter value according to the oil and gas content influencing parameter value, the oil and gas fluidity influencing parameter value and the compressibility influencing parameter value, and a pre-established final produced oil equivalent prediction model;
determining an economic lower limit value of the final produced oil equivalent of the shale oil and gas region to be predicted, according to the production cost data;
determining whether or not the shale oil and gas region to be predicted is a shale oil and gas sweet spot region according to the final produced oil equivalent corresponding to each influencing parameter value and the economic lower limit value of the final produced oil equivalent of the shale oil and gas region to be predicted.

14. The computer device according to claim 13, wherein the oil and gas content influencing parameter includes a total organic carbon content, a maturity of organic matter, and an effective shale thickness; the oil and gas fluidity influencing parameter includes a total porosity of shale and an original formation pressure; the compressibility influencing parameter includes a clay volume content.

15. The computer device according to claim 13, wherein the computer readable instructions cause the processor to establish the final produced oil equivalent prediction model by the following method of:
obtaining oil and gas production data of a shale section production well in a target layer of a research region, as well as an oil and gas content influencing parameter value, an oil and gas fluidity influencing parameter value and a compressibility influencing parameter value of the target layer in the research region;
predicting a final produced oil equivalent of the shale section production well in the target layer of the research region according to the oil and gas production data within a preset time period;
normalizing a horizontal section length, number of fracturing sections, number of fracturing clusters and supporting dose used per meter of the final produced oil equivalent of the production well in the target layer of the research region;
acquiring an average value of the final produced oil equivalent within a preset interval of an influencing parameter value according to the interval by using the normalized values of the final produced oil equivalent of the production well in the target layer of the research region, and establishing a final produced oil equivalent prediction model corresponding to each influencing parameter value.

16. The computer device according to claim 15, wherein the computer readable instructions cause the processor to:
establish a monthly oil and gas production prediction model of the production well according to data of oil production equivalent of the production well in 4 months near the 180th day;
determine an oil equivalent economic lower limit value of the production well according to the monthly oil and gas production prediction model and production cost data;
determine a final produced oil equivalent of the production well according to the oil equivalent economic lower limit value of the production well and oil and gas production of the production well in all previous months.

17. A computer readable storage medium including computer readable instructions, wherein when being executed, the computer readable instructions cause a processor to execute at least the following operations:
acquiring an oil and gas content influencing parameter value, an oil and gas fluidity influencing parameter value and a compressibility influencing parameter value of a shale target layer in a shale oil and gas region to be predicted, and production cost data;
determining a final produced oil equivalent corresponding to each influencing parameter value according to the oil and gas content influencing parameter value, the oil and gas fluidity influencing parameter value and the compressibility influencing parameter value, and a pre-established final produced oil equivalent prediction model;
determining an economic lower limit value of the final produced oil equivalent of the shale oil and gas region to be predicted, according to the production cost data;
determining whether or not the shale oil and gas region to be predicted is a shale oil and gas sweet spot region according to the final produced oil equivalent corresponding to each influencing parameter value and the economic lower limit value of the final produced oil equivalent of the shale oil and gas region to be predicted.

18. The computer readable storage medium including computer readable instructions according to claim 17, wherein the oil and gas content influencing parameter includes a total organic carbon content, a maturity of organic matter, and an effective shale thickness; the oil and gas fluidity influencing parameter includes a total porosity of shale and an original formation pressure; the compressibility influencing parameter includes a clay volume content.

19. The computer readable storage medium including computer readable instructions according to claim 17, wherein the computer readable instructions cause the processor to establish the final produced oil equivalent prediction model by the following method of:
obtaining oil and gas production data of a shale section production well in a target layer of a research region, as well as an oil and gas content influencing parameter value, an oil and gas fluidity influencing parameter value and a compressibility influencing parameter value of the target layer in the research region;
predicting a final produced oil equivalent of the shale section production well in the target layer of the research region according to the oil and gas production data within a preset time period;
normalizing a horizontal section length, number of fracturing sections, number of fracturing clusters and supporting dose used per meter of the final produced oil equivalent of the production well in the target layer of the research region;
acquiring an average value of the final produced oil equivalent within a preset interval of an influencing parameter value according to the interval by using the normalized values of the final produced oil equivalent of the production well in the target layer of the research region, and establishing a final produced oil equivalent prediction model corresponding to each influencing parameter value.

20. The computer readable storage medium including computer readable instructions according to claim 19, wherein the computer readable instructions cause the processor to:
establish a monthly oil and gas production prediction model of the production well according to data of oil production equivalent of the production well in 4 months near the 180th day;
determine an oil equivalent economic lower limit value of the production well according to the monthly oil and gas production prediction model and production cost data;
determine a final produced oil equivalent of the production well according to the oil equivalent economic lower limit value of the production well and oil and gas production of the production well in all previous months.
